(19) United States
(12) Patent Application Publication
(10) Pub. No.: US 2012/0173311 A1
(43) Pub. Date: Jul. 5, 2012

(54) AUTOMATIC TELLER MACHINE FOR PROVIDING SERVICE USING TWO-DIMENSIONAL BARCODE AND METHOD FOR OPERATING AUTOMATIC TELLER MACHINE

(75) Inventors: Bo Ik CHANG, Seongnam-si (KR); Young Man LEE, Bucheon-si (KR)

(73) Assignee: NAUTILUS HYOSUNG INC., Seoul (KR)

(21) Appl. No.: 13/340,056

(22) Filed: Dec. 29, 2011

(30) Foreign Application Priority Data
Dec. 31, 2010 (KR) 10-2010-0140275
Dec. 31, 2010 (KR) 10-2010-0140276
Jan. 19, 2011 (KR) 10-2011-0005353

(51) Int. Cl. G06Q 40/02; G06Q 30/02

(52) U.S. Cl. 705/14.1; 705/43; 705/14.4

(57) ABSTRACT

An automatic teller machine (ATM) providing a service using a two-dimensional (2D) barcode and an operation method thereof may be provided. The ATM may include a scanning unit to scan a 2D barcode from a mobile terminal in response to a request for a transaction request, and a processor to determine a requested financial transaction from the scanned 2D barcode, and to provide a display unit with a service screen supporting the determined financial transaction.

### CROSS-REFERENCE TO RELATED APPLICATIONS

This application claims priority to Korean Patent Application No. 10-2010-0140275, filed on Dec. 31, 2010; Korean Patent Application No. 10-2010-0140276 filed on Dec. 31, 2010; and Korean Patent Application No. 10-2011-0005353, filed on Jan. 19, 2011, which are incorporated herein by reference in their entirety.

### BACKGROUND

1. Field of the Invention

The present invention relates to an automatic teller machine (ATM) providing a two-dimensional (2D) barcode in a mobile terminal that scans the 2D barcode, and an operating method thereof.

2. Description of the Related Art

An automatic teller machine (ATM) has brought varied innovative developments to a traditional financial transaction that provides users with a financial transaction through a teller at a financial institution. The waiting time for the financial transaction may be dramatically reduced, and users are able to perform the financial transaction irrespective of a time and a place, even after the business hours of the financial institution. The financial institution may reduce a time expended for financial services and may be able to improve work efficiency since a number of human resources required and an amount of cost required may be reduced.

The ATM provides various financial services that are substantially performed by the financial institution, for example, banks, village funds, and the like. With respect to financial transactions, such as a remittance transaction, a balance inquiry, a withdrawal transaction, updating of a bankbook, and the like, users may quickly perform a desired financial transaction by simply manipulating the ATM installed in a bank without a contact with a teller in the bank. A number of users of the ATM, a number of ATMs, and a number of locations where the ATM is installed are dramatically increased due to the advantages of the ATM and thus, now the ATM can be readily found everywhere.

When the ATM provides a financial transaction requested by a user, the ATM may require the user to respond to processes based on a process associated with the financial transaction, so as to complete the process. For example, the ATM may require the user to perform processes, that is, requesting of a transaction menu, selecting of withdrawal of cash, and the like, so as to provide a service of withdrawal of cash.

In this example, as a number of processes associated with the financial transaction increases, inconvenience that the users experience may increases and a time expended for the financial transaction may also increases.

Accordingly, there is a desire for a method of readily and promptly processing varied services associated with financial transactions commonly provided by the ATM.

### SUMMARY

An aspect of the present invention provides an automatic teller machine (ATM) that omits a pre-process for a financial transaction by scanning a two-dimensional (2D) barcode, and providing a service screen supporting the financial transaction determined based on the scanned 2D barcode and thus, the financial transaction may be readily performed.

Another aspect of the present invention also provides an ATM that displays first advertisement contents and a 2D barcode, so that second advertising contents associated with the first advertising contents is downloaded to a mobile terminal from an identified service server when the mobile terminal scans the 2D barcode and thus, a user is able to access an advertisement irrespective of a transaction time and a location of the ATM, and an advertising effect may be maximized.

Another aspect of the present invention also provides an ATM that generates and displays a 2D barcode associated with a financial transaction, so that transaction records associated with the financial transaction are displayed on a first terminal when the terminal scans the 2D barcode and thus, printing out of a paper record associated with the transaction may be omitted and a cost expended for printing out a paper record may be reduced.

According to an aspect of the present invention, there is provided an ATM for providing a service using a 2D barcode, the ATM including a scanning unit to scan a 2D barcode from a mobile terminal in response to a request for a transaction request, and a processor to determine a requested financial transaction from the scanned 2D barcode, and to provide a display unit with a service screen supporting the determined financial transaction.

According to an aspect of the present invention, there is provided a method of operating an ATM using a 2D barcode, the method including receiving at least one of card information, a personal identification number (PIN), a facial image, and a finger print image, as user information, in response to a transaction request, scanning, from a mobile terminal, a 2D barcode upon authentication of the input user information, determining a requested financial transaction from the scanned 2D barcode, and providing a display unit with a service screen supporting the determined financial transaction.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an automatic teller machine (ATM) according to an embodiment of the present invention;

FIG. 2 is a diagram illustrating an internal configuration of an ATM providing a service using a two-dimensional (2D) barcode according to an embodiment of the present invention;

FIG. 3 is a diagram illustrating an example of a process associated with a financial transaction provided in an ATM according to an embodiment of the present invention;

FIG. 4 is a diagram illustrating an example of a financial transaction provided in an ATM using a 2D barcode according to an embodiment of the present invention;

FIG. 5 is a flowchart illustrating a method of operating an ATM providing a service using a 2D barcode according to an embodiment of the present invention;

FIG. 6 is a diagram illustrating an internal configuration of an ATM providing an advertisement as a service using a 2D advertising barcode according to an embodiment of the present invention;

FIG. 7 is a diagram illustrating an example of providing an advertisement in an ATM according to an embodiment of the present invention;

FIG. 8 is a diagram illustrating an internal configuration of an ATM providing an itemized account using a 2D barcode according to an embodiment of the present invention; and

FIG. 9 is a diagram illustrating an example of providing an itemized account in an ATM according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

An automatic teller machine (ATM) used throughout the specifications may include a cash dispenser (CD) that provides a service of withdrawing cash, an automatic multifunctional machine that provides varied financial services associated with banks, insurance companies, credit cards, and the like, and all types of automatic machines, for example, a kiosk that provides varied supplementary services including receiving of utility bills, issuing of tickets, saving of points, and the like.

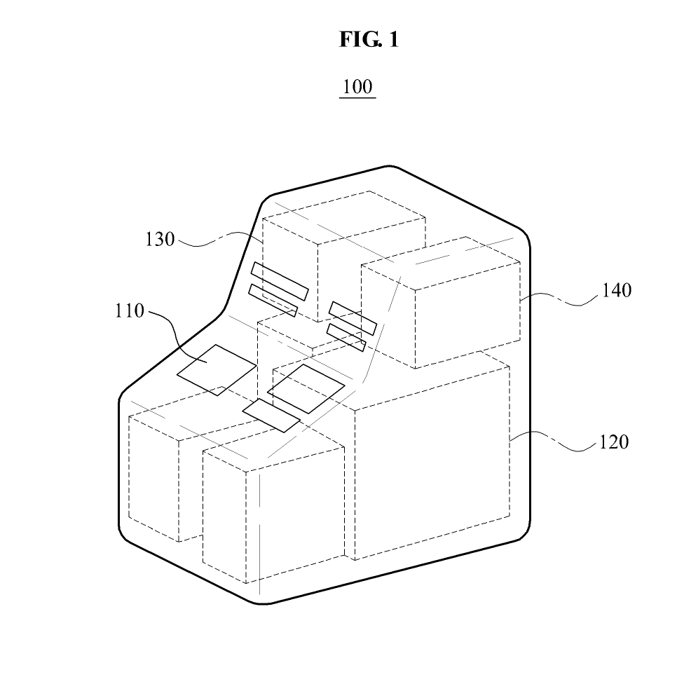

FIG. 1 illustrates an automatic teller machine (ATM) 100 according to an embodiment of the present invention.

The ATM 100 may include a manipulating terminal 110, a banknote unit 120, a bankbook unit 130, and a card reader 140.

The manipulating terminal 110 may receive a manipulation and a selection of a menu for a financial transaction, input by a user, and may provide varied financial services or supplementary services to the user.

The banknote unit 120 may count and store banknotes, and the bankbook unit 130 may read and update a bankbook. The card reader 140 may read a financial transaction card when the user inserts the financial transaction card, and may process a business associated with the card. The card reader 140 may read a card for other businesses, such as a point card, an identification card, and the like, in addition to the financial transaction card.

In addition, the ATM 100 may additionally include a communication unit for providing access to an automatic financial server, a control unit for controlling general operations of the ATM, a memory storing varied pieces of data, a printing module for printing a bankbook or an itemized account, and the like.

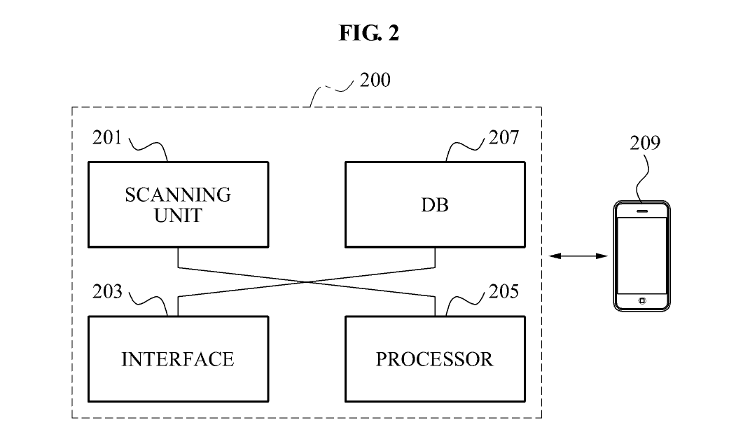

FIG. 2 illustrates an internal configuration of an ATM 200 providing a service using a two-dimensional (2D) barcode according to an embodiment of the present invention.

Referring to FIG. 2, the ATM 200 may include a scanning unit 201, an interface 203, a processor 205, and a database (DB) 207.

A mobile terminal 209 may receive, from the ATM 200, a dedicated application that supports creation of a 2D barcode associated with a financial transaction, in response to a request for downloading. According to an embodiment of the present invention, the mobile terminal 209 may activate the dedicated application upon completion of a process associated with the financial transaction, for example, a pre-process for the financial transaction, the mobile terminal 209 may generate a 2D barcode to include records associated with the process.

For example, when the mobile terminal 209 desires to generate a 2D barcode associated with a withdrawal of cash, the mobile terminal 209 may activate the dedicated application, may select ‘withdraw cash’ from a menu option associated with a pre-process supported by a page where the application is activated, and may perform a process associated with ‘withdraw cash’ through transaction operations, such as entering of a bank account number, and entering of a withdrawal amount, and the like. Subsequently, the mobile terminal 209 may select ‘generate code’ so as to generate a 2D barcode to include records associated with the process performed in advance. The 2D barcode may include, for example, coded information associated with withdrawal of a determined withdrawal amount from a designated account.

Here, the 2D barcode may be provided as a QR code. Hereinafter, for ease of description, the 2D barcode may be described as a QR code.

In some embodiments, the mobile terminal 209 may generate a 2D barcode, for example, a QR code, by receiving records associated with a process performed in another device. That is, the mobile terminal 209 may receive records associated with a process from a personal terminal, for example, a personal computer (PC), that completes the process associated with a financial transaction, and may generate a QR code to include the received records and thus, the mobile terminal 209 may generate the QR code in conjunction with the personal terminal without performing the process again.

The scanning unit 201 may be, for example, a barcode reader, and may scan the QR code from the mobile terminal 209 that generates and maintains the QR code, in response to a transaction request. For example, when the transaction request is input, for example, inserting of a card or selecting of a transaction request button, the scanning unit 201 may recognize a QR code displayed on the mobile terminal 209 located within a predetermined distance, and may scan the QR code.

Although the embodiment describes that a barcode stored in the mobile terminal is transferred in a form of transaction information and the like through a barcode reader of the ATM, the transferring scheme is not limited thereto.

For example, the barcode reader may be a camera, and the ATM may read information in a form of a QR barcode, scanned by the camera corresponding to the barcode reader, so as to identify and transfer transaction information and the like.

For example, the transaction information, that is, a message, may be transferred through wireless communication, for example, near field communication (NFC) and the like, between mobile terminals. That is, the ATM may read the transaction information transferred through the wireless communication.

The interface 203 may receive input user information. The interface 203 may require the user to input the user information before scanning a QR code. In this example, the processor 205 may allow scanning of the QR code upon authentication of the input user information. The user information may be at least one of personal information, a facial image, and a finger print image identified by inputting of a financial card or a personal identification number (PIN).

Accordingly, the ATM may enable a simple financial transaction using a QR code upon completion of authentication and thus, may prevent a financial incident, in advance, that could occur due to indiscriminate scanning of a QR code that requires security.

Although the embodiment describes that the scanning of the QR code is performed immediately after performing authentication, it is not limited thereto. The ATM may provide a menu option including ‘scan QR code’ or ‘standard financial transaction’, and may support a regular transaction procedure, for example, inputting of a withdrawal amount, selecting of a denomination, and the like so as to perform a financial transaction without using a QR code when the user selects ‘standard financial transaction.’

The processor 205 may determine a requested financial transaction based on the scanned QR code, and may provide a service screen supporting the determined financial transaction to a display unit (not illustrated). That is, the processor 205 may immediately provide the service screen supporting the financial transaction determined based on the scanned QR code, and may omit a pre-process for the financial transaction and thus, may provide a simple and quick financial transaction.

For example, the processor 205 may determine the financial transaction from the scanned QR code by decoding coded information associated with a process of withdrawal of cash, for example, information associated with withdrawal of a determined withdrawal amount from a designated account, may provide a service screen supporting the withdrawal of cash and thus, may omit a pre-process for the financial transaction, that is, requesting a transaction menu, and selecting of withdrawal of cash, and may enable the user to withdraw cash quickly.

The processor 205 may determine rights of the user for the financial transaction before scanning a barcode, and may allow scanning of the QR code in the scanning unit 201 when the user has the rights for the financial transaction and thus, a financial transaction security may be improved. For example, when a PIN is input through the interface 203 as the user information, the processor 205 may allow scanning of the QR code when the input user information is authenticated. That is, when the user inserts a card to request a transaction, the processor 205 may extract, from the DB 207, user information corresponding to account information of the inserted card, and may allow scanning of the QR code when the extracted user information is identical to the input user information.

The processor 205 may restrictedly provide a service based on a transaction request time, so as to supplement a security of the financial transaction. For example, the processor 205 may provide the service screen supporting the financial transaction when the transaction request time is included in a valid transaction period extracted from the DB, for example, a year, month, day, or time-based period. Also, the processor 205 may provide the service screen when the transaction request time is included in a valid transaction period extracted from the QR code.

The DB 207 may store at least one of the user information corresponding to the account information and the valid transaction period associated with the QR code. The DB 207 may store at least one of a PIN, a facial image, and a finger print image, as the user information. The DB 207 may store the valid transaction period, based on a year, a month, a day, or a time.

The ATM 200 providing a service using a 2D barcode may additionally include a communication unit (not illustrated) that provides a dedicated-application supporting creation of a 2D barcode associated with a financial transaction, in response to a request for downloading being received from the mobile terminal 209 and thus, may enable the mobile terminal 209 to readily generate the 2D barcode.

Here, the communication unit may provide the dedicated-application to the mobile terminal 209, through NFC.

The communication unit may periodically receive the dedicated-application from an application server (not illustrated) and store the received application in the DB 207, so as to update the application.

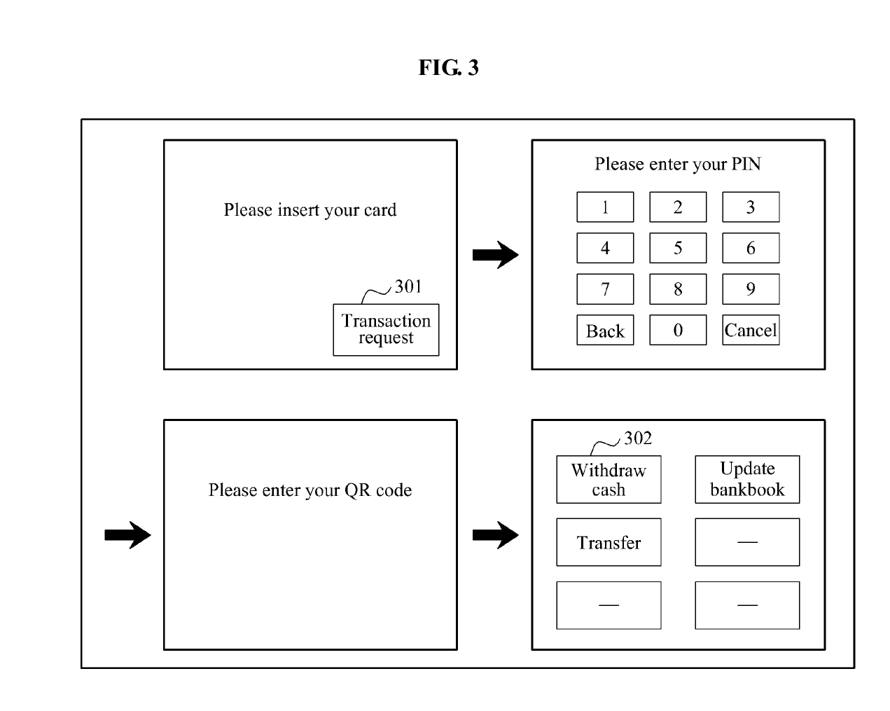

FIG. 3 illustrates an example of a process associated with a financial transaction provided in an ATM according to an embodiment of the present invention.

A personal terminal, for example, a PC, may complete a process associated with a financial transaction, for example, withdrawal of cash, and may provide records of the process to a mobile terminal.

The mobile terminal may generate a QR code to include the records received from the personal terminal or records of a process performed in the mobile terminal itself, and may maintain the generated QR code.

In FIG. 3, an example of a financial transaction when a user of the mobile terminal accesses the ATM and performs a standard financial transaction without using a QR code will be described.

Referring to FIG. 3, the ATM may receive a card and user information, for example, at least one of card information, a PIN, a facial image, and a finger print image, input by the user, in response to a transaction request 301.

Subsequently, the ATM may authenticate the input user information, and may provide a menu button for each type of financial transaction when a QR code is not scanned from the mobile terminal within a predetermined time and thus, may separately support selecting of a type of a transaction. That is, a standard financial transaction may be provided separately.

In this example, when ‘withdraw cash’ 302 is selected, the ATM may provide a service screen supporting withdrawal of cash to a display unit, so that the user withdraws a desired withdrawal amount.

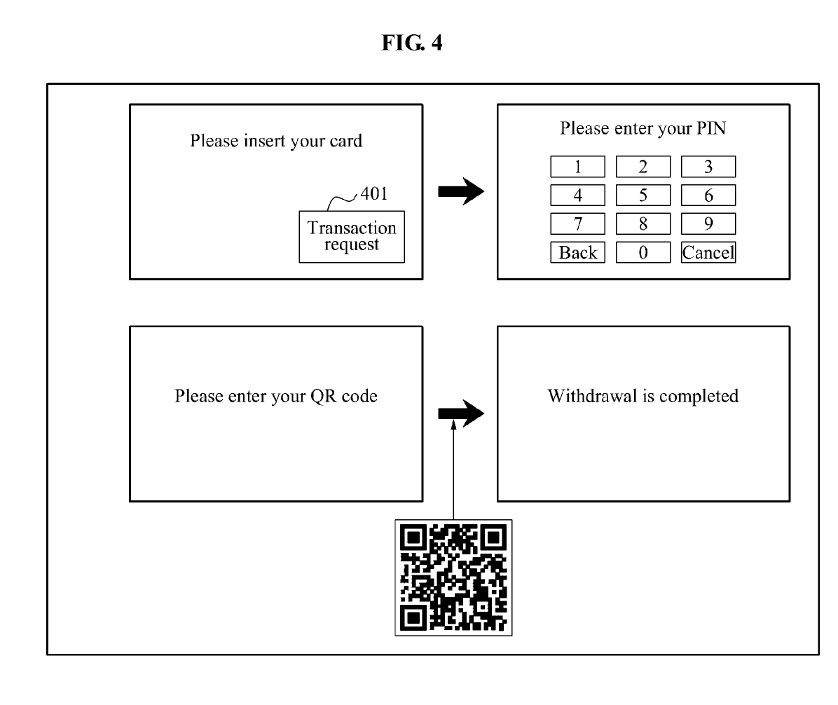

FIG. 4 illustrates an example of a financial transaction provided in an ATM using a 2D barcode according to an embodiment of the present invention.

Referring to FIG. 4, the ATM may receive a card and user information, for example, at least one of card information, a PIN, a facial image, and a finger print image, input by a user, in response to a transaction request 401 from the user.

Subsequently, the ATM may authenticate the input user information, and may allow scanning of a QR code when the input user information is authenticated so as to scan the QR code from a mobile terminal. The ATM that scans the QR code may determine a requested financial transaction based on the QR code, and may provide a service screen supporting the determined financial transaction, for example, withdrawal of cash, so as to complete a service of the financial transaction.

For example, when the requested financial transaction is determined to be withdrawal of cash based on the QR code scanned from the mobile terminal, the ATM may support the withdrawal of cash so as to enable a withdrawal amount included in the QR code to be withdrawn. Accordingly, the ATM may omit a pre-process for the withdrawal of cash, that is, selecting of ‘withdraw cash’, inputting a withdrawal amount, and setting of a denomination, and may immediately provide a service screen supporting the withdrawal of cash when the withdrawal of cash is determined based on the QR code scanned from the mobile terminal and thus, the withdrawal of cash may be readily and promptly performed.

Accordingly, the user may generate a QR code associated with a frequently used financial transaction so as to readily perform the financial transaction through the ATM.

The ATM may request user information, for example, a PIN, for authentication of the user before or after scanning of a QR code.

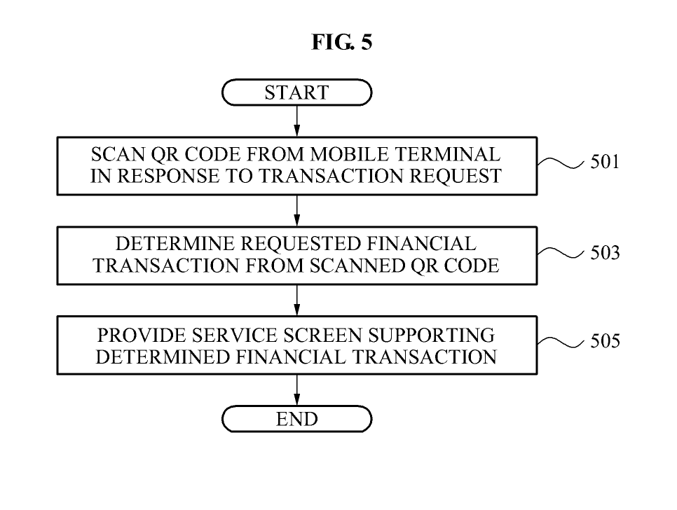

FIG. 5 illustrates a method of operating an ATM providing a service using a 2D barcode according to an embodiment of the present invention.

Referring to FIG. 5, the ATM may scan a QR code from a mobile terminal, in response to a transaction request in operation 501. When the transaction request is input by the user, the ATM may recognize the QR code displayed on the mobile terminal located within a predetermined distance, and may scan the recognized QR code.

In this example, when a card is inserted as the transaction request, the ATM may request the user to input user information. The ATM may receive the user information, for example, a PIN, a card, a facial image, and a finger print image, input by the user, and may allow scanning of the QR code when the input user information is authenticated. For example, the ATM may extract, from a DB, user information corresponding to account information of the inserted card, which is inserted as the transaction request, and may allow scanning of the QR when the extracted user information is identical to the input user information.

Here, the QR code may be generated, by the mobile terminal, to include records of a process associated with a financial transaction, upon completion of the process.

Also, the QR code may be generated to include records, by the mobile terminal that receives the records of a process associated with a financial transaction from the ATM or a personal terminal that completes the process

In operation 503, the ATM may determine a requested financial transaction based on the scanned QR code.

In operation 505, the ATM may provide a service screen supporting the determined financial transaction to a display unit.

The ATM may restrictedly provide a service based on a transaction request time. For example, the ATM may provide the service screen supporting the financial transaction when the transaction request time is included in a valid transaction period, for example, a year, month, day, or time-based period, extracted from the DB.

According to embodiments of the present invention, a pre-process for the financial transaction may be omitted by scanning the QR code and providing the service screen supporting the requested financial transaction determined based on the scanned QR code, and thus, the financial transaction may be readily performed.

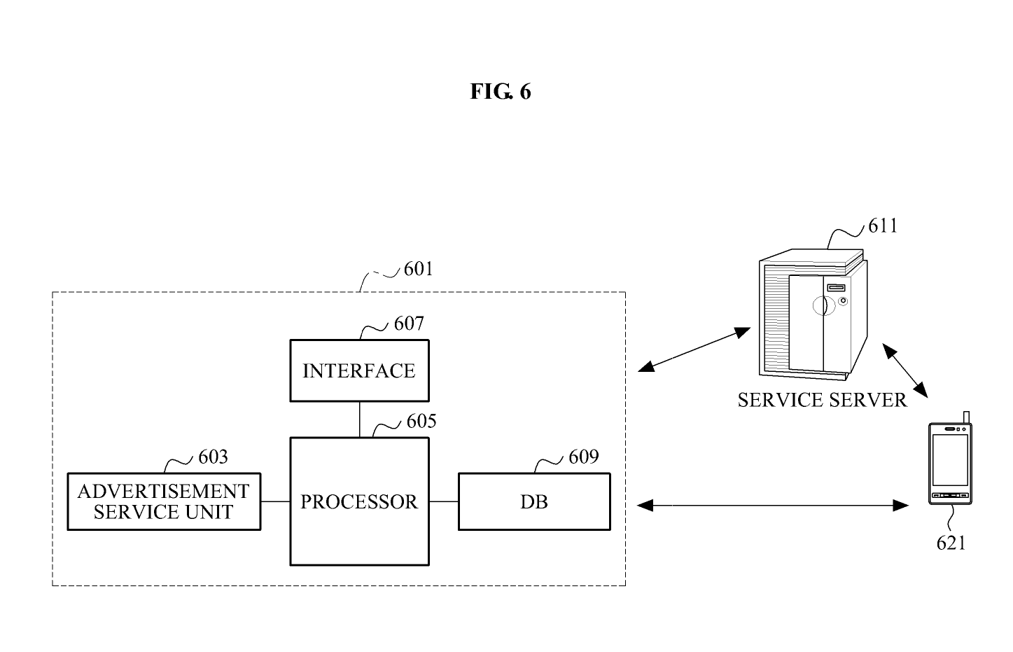

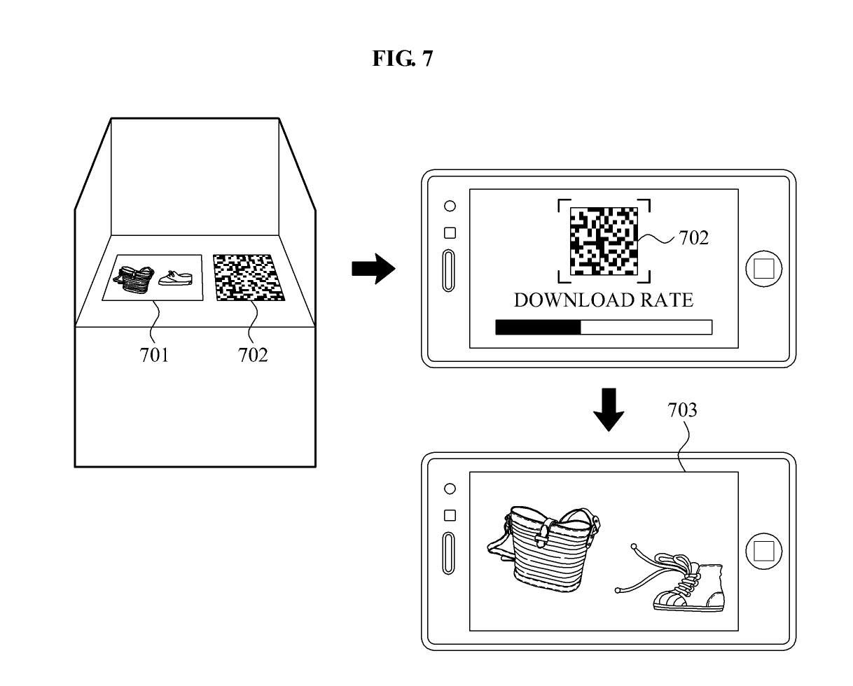

An ATM that enables advertising contents associated with a 2D advertising barcode to be provided in a mobile terminal that scans the 2D advertising barcode will be described with reference to FIGS. 6 and 7.

FIG. 6 illustrates an internal configuration of an ATM 601 providing an advertisement as a service using a 2D advertising barcode according to an embodiment of the present invention.

Referring to FIG. 6, the ATM 601 that provides an advertisement using a QR code may include an advertisement service unit 603, a processor 605, an interface 607, and a DB 609.

The advertisement service unit 603 may display first advertising contents and a 2D advertising barcode on a display unit. Here, the 2D advertising barcode may be provided as a QR code. Hereinafter, for ease of description, the 2D advertising barcode may be described as a QR code.

For example, the advertisement service unit 603 may display first advertising contents and a QR code on a waiting screen, or may display first advertising contents and a QR code extracted from the DB 609 in response to a transaction request, for example, inputting of a transaction request button or inserting a card.

Here, the advertisement service unit 603 may display first advertising contents and a QR code that is different for each predetermined period so as to provide varied types of advertising contents, and the advertisement service unit 603 may display first advertising contents and a QR code based on an inclination of a user for each period so as to provide effective advertising contents to the user.

The advertisement service unit 603 may additionally display advantageous information on the display unit when the mobile terminal 621 completes scanning of the QR code or downloading of second advertising contents. The advertisement service unit 603 may display the advantageous information so as to induce the mobile terminal 621 to scan the QR code or to download the second advertising contents.

When the mobile terminal 621 scans the QR code, the processor 605 may enable the second advertising contents associated with the first advertising contents to be downloaded from an identified service server 611 to the mobile terminal 621. Also, the processor 605 may enable the second advertising contents to be automatically played back when downloading of the second advertising contents to the mobile terminal 621 is completed and thus, advertising contents may be readily displayed to the user.

The QR code includes address information, for example, a uniform resource locator (URL) to be used for identifying the service server 611 and thus, the processor 605 may identify the service server 611 based on the address information. Here, the second advertising contents may be a full version of the first advertising contents, and may include more varied and detailed information when compared to the first advertising contents.

Accordingly, the mobile terminal 621 may automatically download the second advertising contents associated with the first advertising contents from the service server 611, when the QR code is scanned. In this example, the mobile terminal 621 may be able to download all of second advertising contents unless an event associated with an interruption of the downloading is transmitted to the service server 611. The service server 611 may transmit, to the ATM 601, an event associated with the completion of downloading of the second advertising contents to the mobile terminal 621 when all of second advertising contents are provided to the mobile terminal 621.

The processor 605 may activate advantageous information registered in association with the reception of the event through an interface 607 when the event associated with the completion of downloading of the second advertising contents is received. For example, when the advantageous information is associated with points or a coupon for deduction of a transaction fee, the processor 605 may activate the advantageous information so as to deduct a transaction fee charged for a financial transaction using the points or the coupon. In this example, the processor 605 may display the activated advantageous information, so that the user may recognize the advantageous information.

Accordingly, the processor 605 may determine an activation state of the advantageous information when the financial transaction is performed in response to the transaction request, and may apply the activated advantageous information, for example, deducting of the transaction fee, when the advantageous information is activated, so that the user has an advantage. Accordingly, the downloading of the second advertising contents may be more actively induced.

The interface 607 may receive, from the service server 611, the event associated with the completion of downloading of the second advertising contents to the mobile terminal 621.

The DB 609 may store first advertising contents and a QR code corresponding to the first advertising contents. The DB 609 may store the first advertising contents and the QR code by receiving them from the service server 611, and may periodically update the first advertising contents and the QR code. Also, the DB 609 may store the first advertising contents and the QR code to correspond to a period for displaying advertising contents.

According to an embodiment of the present invention, the ATM 601 may display first advertising contents and a QR code, second advertising contents associated with the first advertising contents may be downloaded from an identified service server to the mobile terminal 621 when the mobile terminal 621 scans the QR code, and the user is able to access advertising contents irrespective of a transaction time and a location where the ATM is installed and thus, an advertising effect may be maximized.

According to an embodiment of the present invention, second advertising contents, that is, a full version of the first advertising contents may be downloaded to the mobile terminal 621, and thus, more varied and detailed advertising contents may be provided.

FIG. 7 illustrates an example of providing an advertisement in an ATM according to an embodiment of the present invention.

Referring to FIG. 7, the ATM may display first advertising contents 701 and a QR code 702, in response to a transaction request.

A mobile terminal may scan the QR code displayed on the ATM using a camera module, and simultaneously, may download second advertising contents 703 associated with the first advertising contents 701 from a service server. In this example, the mobile terminal may be provided with the second advertising contents 703, as a full version of the first advertising contents 701, from the service server, identified by address information included in the QR code 702.

The mobile terminal may play back the second advertising contents 703 upon the completion of downloading of the second advertising contents 703, so as to enable the user to readily access advertising contents.

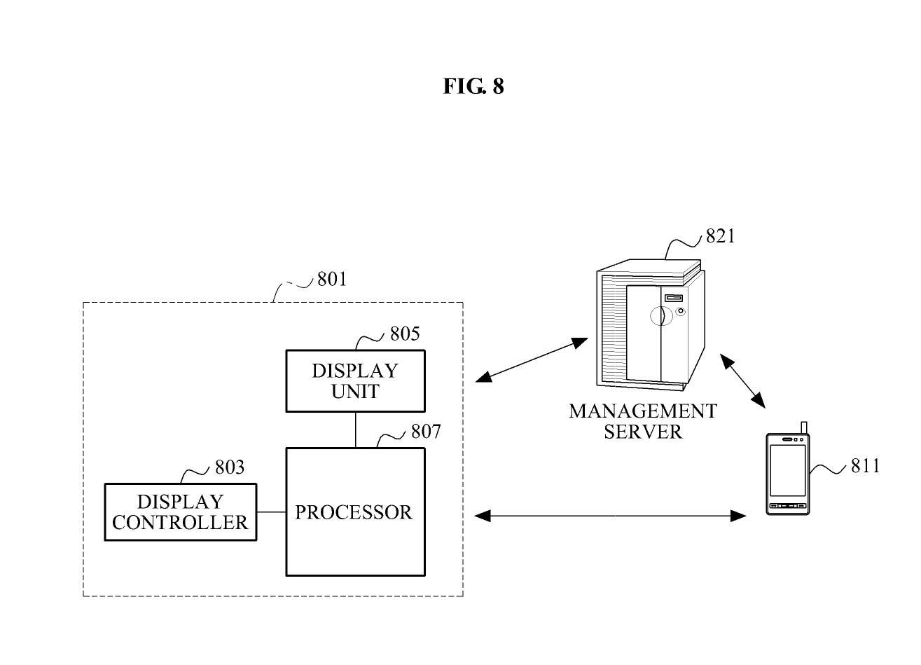

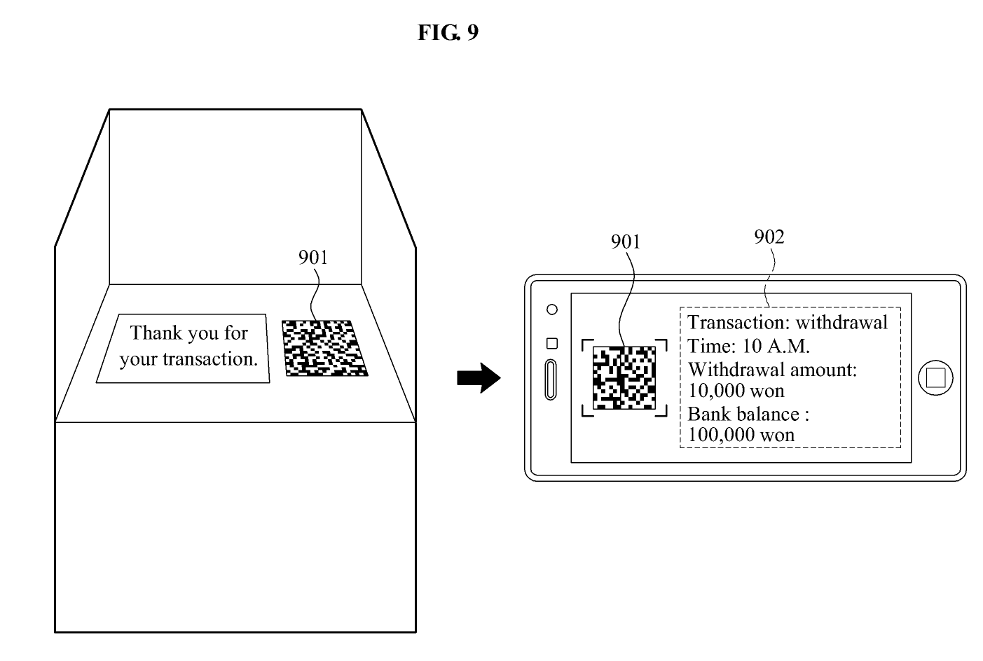

Hereinafter, an ATM that provides records of a financial transaction associated with a 2D barcode, to a mobile terminal that scans the 2D barcode will be described with reference to FIGS. 8 and 9.

FIG. 8 illustrates an internal configuration of an ATM 801 providing an itemized account using a 2D barcode according to an embodiment of the present invention.

Referring to FIG. 8, the ATM 801 may include a display controller 803, a display unit 805, and a processor 807.

The display controller 803 may generate a 2D barcode associated with a financial transaction in response to the completion of the financial transaction, and may display the 2D barcode on the display unit 805. Here, the 2D barcode may be provided as a QR code. Hereinafter, for ease of description, the 2D barcode may be described as a QR code.

For example, the display controller 803 may generate and display a QR code associated with a financial transaction, for example, ‘withdraw cash’, ‘transfer’, and the like, when the financial transaction is completed.

Here, the QR code may include transaction records, and may include at least one of a type of transaction, a transaction amount, a serial number of a banknote, and a transaction time, as the transaction records.

The display controller 803 may receive, from a management server 821, the QR code and display the QR code, in response to an inquiry request being received from a first terminal 811. That is, the display controller 803 may extract identification information associated with the financial transaction from the inquiry request being received from the first terminal 811, may receive a QR code corresponding to the extracted identification information from the management server 821, and may display the received QR code on the display unit 805. Here, the first terminal 811 may be a mobile terminal, for example, a smart phone.

The display unit 805 may display a QR code based on the control of the display controller 803. The display unit 805 may display a menu for backup of the QR code along with the QR code.

The processor 807 may provide an electronic itemized account when the first terminal 811 scans the QR code and transaction records of the completed financial transaction is displayed on the first terminal 811. That is, the first terminal 811 may scan the QR code through a scanning unit, for example, a camera module, may display transaction records included in the QR code, and may provide detailed information associated with the financial transaction.

The scanned QR code may be transmitted from the first terminal 811 to the management server 821 in response to a request for backup transmission being received from the first terminal 811. That is, the first terminal 811 may transmit the scanned QR code to the management server 821 when the request for the backup transmission with respect to the scanned QR code is received.

The processor 807 may transmit the QR code to the management server 821 in response to the request for the backup transmission associated with selection of a menu displayed on the display unit 805.

The management server 821 may mange a QR code received from the first terminal 811 or the ATM 801. The management server 821 may provide the QR code to a second terminal in response to an inquiry request being received from the second terminal different from the first terminal 811, so that the first terminal 811 scans the QR code provided to the second terminal and transaction records may be displayed on the first terminal 811. Here, the second terminal may be a personal terminal, for example, a PC.

Accordingly, the first terminal 811 may obtain a QR code through the second terminal that receives the QR code from the management server 821 even when the first terminal 811 does not scan the QR code immediately after completing a financial transaction in the ATM 801.

According to an embodiment of the present invention, a QR code associated with a financial transaction may be generated and displayed in response to the completion of the financial transaction, and the first terminal 811 may scan the QR code and transaction records associated with the financial transaction may be displayed on the first terminal 811 and thus, a paper associated with the transaction records, that is, an itemized account, may not need to be printed out. Accordingly, a cost expended for printing out the paper, for example, a cost of paper, a cost of human resources for supplying paper, and the like, may be reduced.

According to an embodiment of the present invention, the interruption of the operation due to a paper shortage or a problem caused by paper may be prevented in advance by omitting printing out of a paper associated with the transaction records.

FIG. 9 illustrates an example of providing an itemized account in an ATM according to an embodiment of the present invention.

Referring to FIG. 9, the ATM may generate a QR code 901 associated with a financial transaction in response to the completion of the financial transaction, and may display the QR code 901. That is, the ATM may display the QR code 901 along with a message associated with the completion of the financial transaction.

A terminal may display transaction records 902 associated with the financial transaction by scanning the QR code 901 displayed on the ATM using a camera module. Here, the transaction records 902 may include a type of a transaction, for example, ‘withdraw cash’, a transaction time, for example, ten a.m., a withdrawal amount, for example, 10,000 won, and a bank balance, for example, 100,000 won.

A user may readily check detailed information associated with the financial transaction along with information associated with whether the financial transaction is processed well. Accordingly, the user may not need to possess a paper or an itemized account associated with the transaction records to check or manage the transaction records.

Example embodiments may provide an automatic teller machine (ATM) that omits a pre-process for a financial transaction by scanning a two-dimensional (2D) barcode and providing a service screen supporting the financial transaction determined based on the scanned 2D barcode and thus, the financial transaction may be readily performed.

Example embodiments may provide an ATM that displays first advertisement contents and a 2D barcode, so that second advertising contents associated with the first advertising contents is downloaded to a mobile terminal from an identified service server when the mobile terminal scans the 2D barcode and thus, a user is able to access an advertisement irrespective of a transaction time and a place where the ATM is located, and an advertising effect may be maximized.

Example embodiments may provide an ATM that enables second advertising contents, that is a full version of first advertising contents to be downloaded to a mobile terminal and thus, more varied and detailed advertising contents may be provided.

Example embodiments may provide an ATM that generates and displays a 2D barcode associated with a financial transaction, so that transaction records associated with the financial transaction are displayed on a first terminal when the terminal scans the 2D barcode and thus, printing out of a paper record associated with the transaction may be omitted and a cost expended for printing out a paper record may be reduced.

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An automatic teller machine (ATM) for providing a service using a two-dimensional (2D) barcode, the ATM comprising:
a scanning unit to scan a 2D barcode from a mobile terminal in response to a request for a transaction request; and
a processor to determine a requested financial transaction from the scanned 2D barcode, and to provide a display unit with a service screen supporting the determined financial transaction.

2. The ATM of claim 1, wherein the 2D barcode is generated, in the mobile terminal, to include records of a process associated with the financial transaction, upon completion of the process.

3. The ATM of claim 1, wherein the 2D barcode is generated, in the mobile terminal that receives records of a process associated with the financial transaction from a personal terminal that completes the process, to include the records.

4. The ATM of claim 1, further comprising:
an interface to receive user information,
wherein the processor allows scanning of the 2D barcode upon authentication of the input user information.

5. The ATM of claim 4, wherein the interface receives at least one of a personal identification number (PIN), a facial image, and a finger print image, as the user information.

6. The ATM of claim 1, wherein the processor provides the service screen when a transaction request time is included in a valid transaction period extracted from a database (DB).

7. The ATM of claim 1, further comprising:
a communication unit to provide the mobile terminal with a dedicated application for supporting creation of a 2D barcode associated with a financial transaction, in response to a request for download being received from the mobile terminal.

8. The ATM of claim 1, further comprising:
an advertisement service unit to display first advertising contents and a 2D advertising barcode on the display unit,
wherein the processor enables second advertising contents associated with the first advertising contents to be downloaded to the mobile terminal from an identified service server when the mobile terminal scans the 2D advertising barcode.

9. The ATM of claim 8, wherein the advertisement service unit additionally displays advantageous information on the display unit when the mobile terminal completes scanning of the 2D advertising barcode or downloading of the second advertising contents.

10. The ATM of claim 8, further comprising:
an interface to receive, from the service server, an event associated with the completion of downloading of the second advertising contents to the mobile terminal,
wherein the processor activates advantageous information registered in association with the reception of the event.

11. The ATM of claim 10, wherein, when the advantageous information is associated with points or a coupon for deduction of a transaction fee, the processor activates the advantageous information so as to deduct a transaction fee charged for a financial transaction, using the points or the coupon.

12. The ATM of claim 8, wherein the 2D advertising barcode comprises address information to identify the service server providing the second advertising contents, which is a full version of the first advertising contents.

13. The ATM of claim 8, further comprising:
a display controller to generate a 2D barcode associated with the financial transaction and to display the 2D barcode, in response to completion of the financial transaction,
wherein the processor enables transaction records of the completed financial transaction to be displayed on a first terminal when the first terminal scans the 2D barcode.

14. The ATM of claim 13, wherein the processor transmits the 2D barcode to a management server in response to a request being received for a backup transmission associated with selection of a menu option displayed on the display unit.

15. The ATM of claim 13, wherein the scanned 2D barcode is transmitted from the first terminal to a management server, in response to the request for backup transmission being received from the first terminal.

16. The ATM of claim 14, wherein the display controller receives the 2D barcode from the management server so as to display the received 2D barcode on the display unit, in response to an inquiry request being received from the first terminal.

17. The ATM of claim 14, wherein the management server provides the 2D barcode to a second terminal in response to an inquiry request being received from the second terminal, so that the transaction records are displayed on the first terminal when the first terminal scans the 2D barcode provided to the second terminal.

18. The ATM of claim 13, wherein the 2D barcode comprises at least one of a type of transaction, a transaction amount, a serial number of a banknote, and a transaction time, as the transaction records.

19. A method of operating an automatic teller machine (ATM) using a two-dimensional (2D) barcode, the method comprising:
receiving at least one of card information, a personal identification number (PIN), a facial image, and a finger print image, as user information, in response to a transaction request;
scanning, from a mobile terminal, a 2D barcode upon authentication of the input user information;
determining a requested financial transaction from the scanned 2D barcode; and
providing a display unit with a service screen supporting the determined financial transaction.

20. The method of claim 19, wherein the providing comprises:
providing the service screen when a transaction request time is included in a valid transaction period.
